(19) United States
(12) Patent Application Publication
(10) Pub. No.: US 2016/0311564 A1
(43) Pub. Date: Oct. 27, 2016

(54) Heat-able On-the-Go Food Products Apparatus and Method

(71) Applicant: Frito-Lay North America, Inc., Plano, TX (US)

(72) Inventors: Eduard EDWARDS, Arlington, TX (US); David LeSTAGE, McKinney, TX (US)

(21) Appl. No.: 15/203,569

(22) Filed: Jul. 6, 2016

Related U.S. Application Data
(62) Division of application No. 14/612,870, filed on Feb. 3, 2015.

(51) Int. Cl. B65B 29/08; B05D 3/00; B65C 3/08; B05D 1/02; B65B 7/28; B65B 61/20

(52) U.S. Cl. CPC B65B 29/08; B65B 7/28; B65B 61/202; B65C 3/08; B05D 1/02; B05D 3/007

(57) ABSTRACT

A molded pulp base container sprayed with a barrier and a sealant layer, used as a heat-able package for on-the-go (OTG) food products is disclosed. The container by itself, in one embodiment, is used for microwave/oven heating the food contents in the container, eliminating the need for a separate susceptor or an additional package for heating. The inside surface of the container is spray coated with a food safe poly layer to create a moisture/oxygen barrier for shelf life stability. A sealant layer is directly applied on top of the barrier layer to provide hermesicity for the container. Adding a brine solution and a percentage of sodium to the finished package formulation, selectively heats the food contents of the package while keeping the package itself cool enough to handle. In another system embodiment, a condiment package is fitted to a formed top of the container.

This application is a divisional of, and claims priority to, U.S. Nonprovisional patent application Ser. No. 14/612,870, filed Feb. 3, 2015, which is incorporated by reference in its entirety.

### FIELD OF THE INVENTION

The present invention relates to an on-the-go food package that is hermetically sealed to facilitate heating of the contents of the package and barrier protected for extended shelf life of the contents.

### PRIOR ART AND BACKGROUND OF THE INVENTION

### Prior Art Background

Modern society is on the go, and there is plenty of demand for a quick bite at all times of the day. Busy citizens demand quick meal options. There is a need for quick on-the-go (OTG) foods that can be heated in a microwave or turbochef.

It is also desirable to consume some food products at temperatures above room temperature. This is frequently the case when a food that has been cooked is being consumed. Ideally, a consumer wants to eat the food shortly after it has been prepared so it is still warm. The on-the-go food products are typically heated in a microwave, on a stove, inside a hot air oven, or other known heating method, shortly before they are consumed. Similarly, many examples of commercially available refrigerated and frozen foods exist in the marketplace, which are also heated shortly before consumption.

On-the-go food products, such as pasta, noodles, rice, pizza, soups, sandwiches, tortilla chips, instant oatmeal, cereals, grits, and potato fries are typically sold to consumers in individual single serving or multiple serving packages from convenience stores or grocery stores. The food products are typically packaged in non-microwavable packages. Therefore, the food products need to be transferred into a microwavable/heat-able container and then heated before consumption. Currently, heating is accomplished by adding a separate susceptor or an added package container for heating. Some food packages provide a microwavable/heat-able container as a separate piece in the overall package. Most convenience and grocery stores provide microwave oven or turbochef oven for heating. However, prior art fails to disclose packaged direct contact food which is microwaveable/heat-able using the actual packaging itself to create/control the product heating in the microwave oven. Consequently, a need exists for a package of food that allows a consumer to directly heat and consume the food products inside.

In the case of on-the-go food products, cooking and packaging technology enables market participants to store and sell on-the-go food products for weeks or months at room temperature after they have been cooked, before they lose their desirable organoleptic properties, become stale, or become microbially unstable. Such products are known in the industry as shelf stable food products. Shelf stable food products require packaging with sufficient barrier properties to moisture and oxygen migration in order to keep the food products from becoming microbially unstable.

Prior art fails to disclose an on-the-go food product/package that has direct food contact, shelf stable with moisture/oxygen barrier, hermetically heat sealed, multiple product combinations meal replacement, microwave and turbochef oven cooking safe.

Consequently, there is a need for an on-the-go food container that accomplishes the following objectives:
Provide for an on-the-go packaged direct contact food which is microwaveable using the actual package itself to create/control the product heating in the microwave oven.
Provide for an on-the-go food products for producing “food grade packaging” that could be heated by itself without affecting the shelf life.
Provide for an on-the-go food products with food grade sealant material that can hermetically seal and shut the container.
Provide for an on-the-go food products with food grade sealant material that can be spray coated for easy separation during recycling process.
Provide for an on-the-go food products with food grade material that acts as a barrier to both oxygen and moisture migration products.
Provide for an on-the-go food products with additives to the container material to control the rate of heating of the package and the food contents.
Provide for an on-the-go food products with additives to the container material to reduce cook time for the food products.
Provide for an on-the-go food product container manufacturing methods comprising eco-friendly and minimally waste producing process steps.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention in various embodiments addresses one or more of the above objectives in the following manner. The invention includes a molded pulp base container sprayed with a barrier and a sealant layer, used as a heat-able package for on-the-go (OTG) food products. The container by itself, in one embodiment, is used for microwave/oven heating the food contents in the container, eliminating the need for a separate susceptor or an additional package for heating. The inside surface of the container is spray coated with a food-safe poly layer to create a moisture/oxygen barrier for shelf life stability. A sealant layer is directly applied on top of the barrier layer to provide hermesicity for the container. Adding a brine solution and a percentage of sodium to the finished package formulation, selectively heats the food contents of the package while keeping the package itself cool enough to handle. In another system embodiment, a condiment package is fitted to a formed top of the container.

The present invention system may be utilized in the context of method of making a heat-able container for storing and heating food, the method comprises the steps of:

(1) mixing a pulp slurry;

(2) molding a container comprising a formed top from the pulp slurry;

(3) drying the molded container;

(4) spraying a barrier layer directly to an inside surface of the molded container;

(5) drying the molded container;

(6) spraying a sealant layer directly on top of the barrier layer;

(7) drying the container;

(8) curing the container;

(9) adding food products into the container; and

(10) sealing said container with the formed top.

Integration of this and other preferred exemplary embodiment methods in conjunction with a variety of preferred exemplary embodiment systems described herein in anticipation by the overall scope of the present invention.

### BRIEF DESCRIPTION OF THE DRAWINGS

For a fuller understanding of the advantages provided by the invention, reference should be made to the following detailed description together with the accompanying drawings wherein:

FIG. 1 is a perspective view illustrating a heat-able food package with a closed formed top according to an exemplary embodiment of the present invention.

FIG. 2 is a perspective view illustrating a heat-able food package with an open formed top according to an exemplary embodiment of the present invention.

FIG. 3 is a perspective view illustrating a heat-able food package with a condiment package fitted inside according to an exemplary embodiment of the present invention.

FIG. 4 is a perspective view illustrating a heat-able food package with a condiment package fitted to the outside surface of the formed top according to an exemplary embodiment of the present invention.

FIG. 5 is a cross-sectional view illustrating a barrier layer and a sealant layer according to an exemplary embodiment of the present invention.

FIG. 6 is a perspective view illustrating a circular bowl shaped heat-able food package with a closed formed top according to an exemplary embodiment of the present invention.

FIG. 7 illustrates a flowchart for manufacturing on-the-go heat-able food package according to an exemplary embodiment of the present invention.

### DESCRIPTION OF THE PRESENTLY EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently exemplary embodiment, wherein these innovative teachings are advantageously applied to the particular problems heat-able on-the-go food products apparatus and method. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Exemplary Embodiment Heat-Able Package (1000-2000)

The term “on-the-go food product” as used herein is defined as a food product that is consumed for snacking or meal purposes. The term “microwavable” as used herein is any container/vessel that can be safely used without degrading/deforming in a microwave as recommended by regulatory standards. It should be noted that the term “package”, Package container”, and “container” are used inter-changeably to indicate an article that is shaped to hold food products.

One aspect of the present invention provides consumers with a direct contact food package purchased at grocery or convenience stores which is microwaveable/heat-able using the actual packaging itself. Another aspect of the present invention involves adding salt and/or brine solution to the container to create/control the OTG food product heating in the microwave or hot air oven. The present invention is also directed towards a method of heating food products such as tortilla chips and oatmeal using microwave energy, in a microwave oven or a hot air oven such as turbochef.

The microwave oven is an appliance that can be found in many homes and businesses. During operation, a microwave oven floods the cooking chamber with non-ionizing microwave radiation, usually at a frequency of about 2.45 GHz. Another commonly used microwave frequency is 915 MHz. The power level of most consumer grade microwaves varies from about 900 Watts to about 1400 Watts.

Many food molecules (for example water molecules) are electric dipoles, which means they are positively charged at one end and are negatively charged at the other end. As the microwave radiation passes through the food, the dipole molecules rotate as they try to align themselves with the alternating electric field of the microwaves. This rotation and movement causes the food to heat up as the rotating molecules impact other molecules, putting them into motion. Microwave heating is highly efficient on liquid water (which is a relatively polar molecule), and much less so on fats and sugars (which are less polar).

The microwave radiation can be produced by a cavity magnetron, and directed into the food chamber through a waveguide. The waveguide in most small, consumer grade microwaves directs the microwave radiation into the food chamber from one side of the food chamber, usually at a location between the middle and the top of the food chamber. The microwave radiation generally reflects off the walls of the food chamber, but is absorbed by any water-bearing food present in the food chamber, thereby exciting the water molecules. The radiation reflecting around inside the food chamber forms an approximately uniform heating environment, with some localized hotspots due to constructive and/or destructive interference between microwaves.

The term “hot air oven” as used herein is a control system that precisely coordinates impinged air (which evenly browns the outside of food) with microwave energy (which evenly cooks the inside) to rapidly cook food without compromising quality. Some examples of hot air ovens are products manufactured by TurboChef Technologies, Inc.

Applicants herein have created a food package that enables a consumer to heat OTG food product in the microwave or a hot air oven without the need for an additional microwavable susceptor in the package. In one embodiment, the package is a microwave-safe container that comprises a pulp material, wherein the inner surface of the container is coated with a barrier layer and a sealant layer. There are a number of embodiments of this invention which fall within the scope of the invention in its broadest sense.

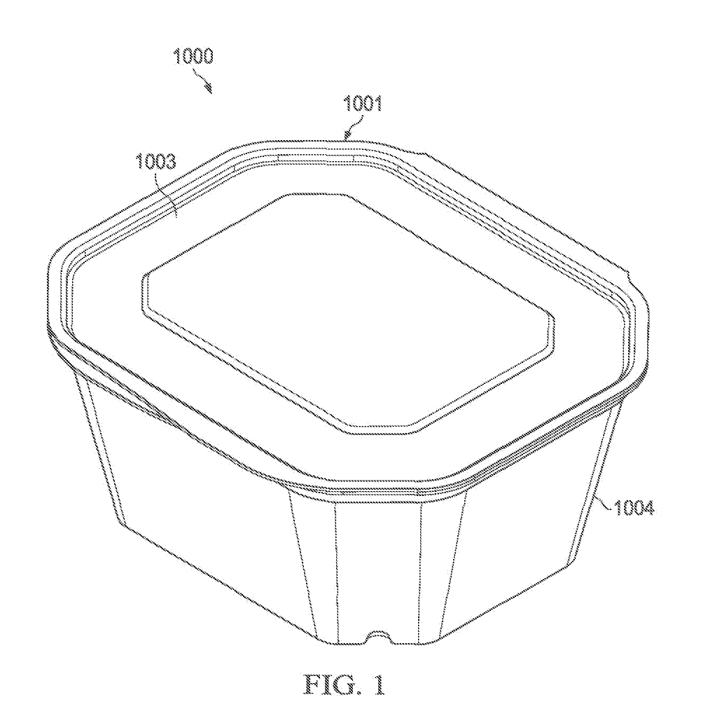

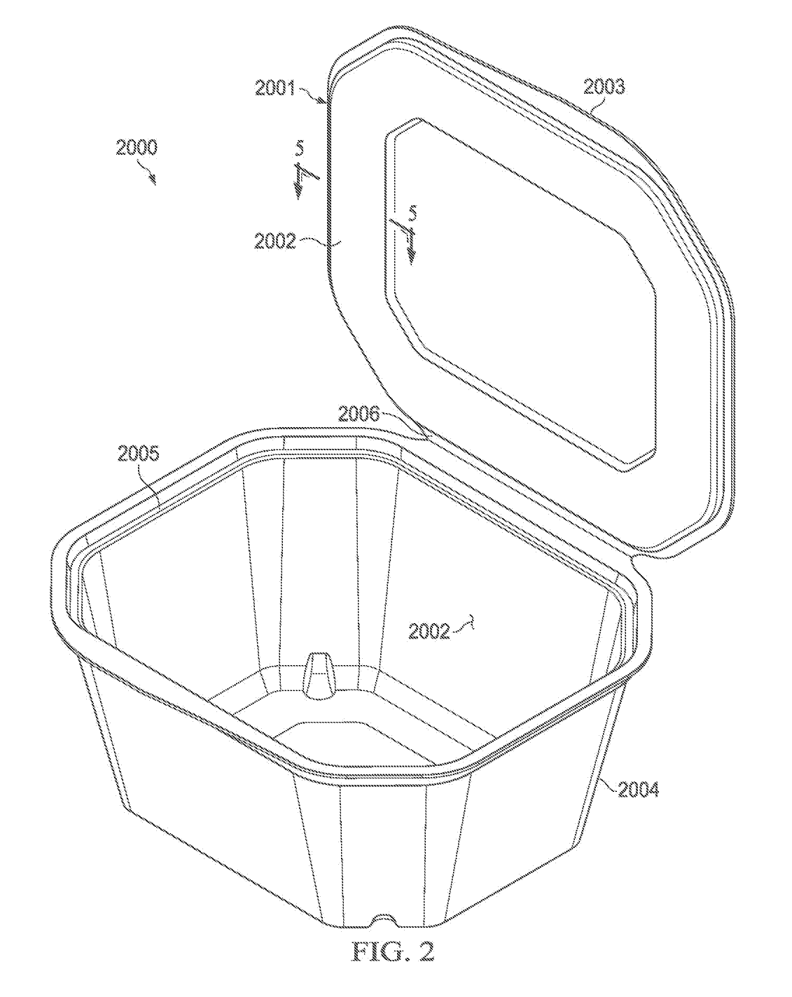

The present invention may be seen in more detail as generally illustrated in FIG. 1 and FIG. 2, wherein a heat-able container (1001) comprising a paper pulp material shaped shell to hold said food and a “closed” formed top (1003) attached to a bottom portion (1004). As illustrated in FIG. 2 (2000), the container (2001) comprises an “opened” formed top (2003) attached to a bottom portion (2004). The formed top (2003) may be attached to the bottom portion (2004) of the container (2001) in such a way as to enable the formed top (2003) to open and/or close the container about a common axis (2006). FIG. 1 illustrates a closed position of the formed top (1001) and FIG. 2 illustrates an opened position of the formed top (2001).

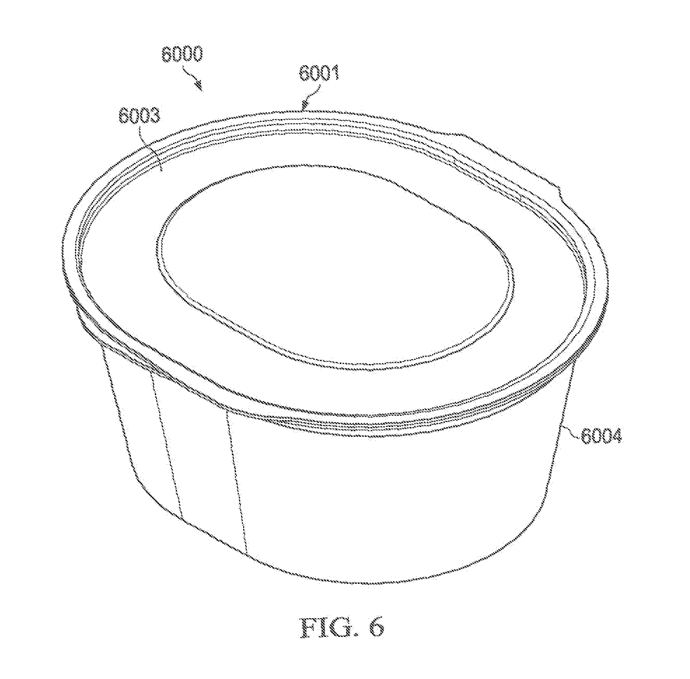

Similar to the generally illustrated rectangular shaped container in FIG. 1, a bowl shaped heat-able shell (6001) made of paper pulp comprising a “closed” formed top (6003) attached to a bottom base (6004) is illustrated in FIG. 6 (6000).

The pulp packaging material, in a preferred exemplary embodiment, is made from 100% post-industrial raw materials and no chemicals are added during the pulping process. According to an exemplary embodiment, the pulp material composition comprises water, natural emulsified wax, and recycled corrugate material. For example, the composition may be 5% natural emulsified wax, 10% water, and 80% recycled corrugate material. In another example, the composition may be 20% natural emulsified wax, 10% water, and 70% recycled corrugate material. The composition may be in the range of 1-20% natural emulsified wax, 1-30% water, and 50-95% corrugate material. Typical uses of molded products are for packaging electronic equipment, cellular phones, and other household and hardware items. Very high-capacity, high-speed molding equipment is used to produce drink trays, cup carriers, wine shippers, egg cartons, egg trays, pulp bedpan liners, fruit trays, slipper pans, end caps, etc. But, pulp material has not been used for “direct contact” food packaging.

Applicants herein have created a food package with pulp material that has other properties such as:
moisture absorption to absorb sprayed barrier;
adhesion to enable a barrier layer to stick to the rough side of the fibrous material;
insulation to keep the outside of the package warm enough after heating, such that a container can be held by a human without substantially causing burn;
lower weight so that it is easily held;
recyclable and eco-friendly as it is bio-degradable;
moldable from a commonly available pulp slurry;
waste-free manufacturing due to minimal water use and recycling used in the process;
rigid properties to sufficiently withstand shipping and handling;
thermally stable to withstand microwave and hot air heating up to 500° C.; and
environmentally safe due to insignificant outgassing of toxic chemicals. The levels are insignificant as deemed by environmental regulatory agencies.

According to one exemplary embodiment, the inside surface of the shell is coated with a barrier layer that reduces the rate of moisture and oxygen migration through the container. The barrier layer may be needed to keep the food products fresh and also keep the food from becoming microbially unstable. In addition, the barrier layer may help extend the shelf life of the package, in some cases by more than 6 months. In one exemplary embodiment, the barrier layer is made from a material such as Michem® Coat 95 manufactured by Michelman, Inc. The material may be water-based coatings that are selected primarily for grease and oil resistance. Other benefits of the Michem® Coat 95 material include water resistance, release, coldset gluability, hot melt, gluability, and recyclability. The barrier layer has thermal properties to withstand heat in a microwave or hot air oven and also adhesive properties to stick to the fibrous side of the container (2002). The barrier layer material is also food safe.

According to yet another exemplary embodiment, a sealant layer that is food safe is directly applied on top of the barrier layer. The sealant layer is exposed to the “food side” and is in direct contact with the food contents. The sealant layer material, in one preferred exemplary embodiment, is Michem® Coat 1398.E manufactured by Michelman, Inc. The properties of which are shown below:

| | | | | | Classification | REACH |
|---|---|---|---|---|---|---|
| | | | | Classification | CLP EC No. | Registration |
| Chemical Name | CAS-No | EC-No | Weight % | (1999/45/EC) | 1272/2008 | Number |
| AMMONIUM HYDROXIDE | 1336-21-6 | 215-647-6 | <1 | C; R34 | Skin Corr. 1B | 01-2119488876-14 |
| | | | | N; R50 | (H314) | |
| | | | | | Aquatic Acute 1 | |
| | | | | | (H400) | |
| | | | | | STOT SE 3; H335: | |
| | | | | | C = 5% | |

A cross-section of the inside surface after the application of the barrier and sealant layers is illustrated in FIG. 5 which will be discussed further below. According to yet another exemplary embodiment, multiple barrier and sealant layers may be sprayed to achieve the desired leakage and barrier properties.

According to a further exemplary embodiment, addition of a brine solution or adding a percentage of sodium to the finished package formulation controls the moisture content of the package. According to a preferred exemplary embodiment, the percentage of salt in the finished package formulation may range from 0-40% by weight. According to a more preferred exemplary embodiment, the percentage of salt in the finished package formulation may range from 0-20% by weight. According to a most preferred exemplary embodiment, the percentage of salt in the finished package formulation may range from 0-10% by weight. The salt content within the package formulation may work with the microwave oven to activate the molecules to heat the product inside the pulp package. The added sodium in the pulp package helps drive the heat towards the food contents in the inside of the package while keeping the outside relatively cooler. This assists with the handling of the package with a human hand after the package has been removed from the microwave or hot air oven.

The thickness of the pulp layer may be varied to alter the thermal characteristics such that the food contents are rapidly heated while keeping the container cool. In one exemplary embodiment, the thickness of the pulp layer is between 1 mil and 50 mils. In a preferred exemplary embodiment, the thickness of the pulp layer is between 20 mils and 40 mils. In the most preferred exemplary embodiment, the thickness of the pulp layer is between 25 mils and 35 mils. For example, the thickness may be increased to reduce the cook time. According to yet another exemplary embodiment, thermal characteristics of the container may be changed to cook food contents rapidly with the salt additive, brine solution additive, and/or varying the thickness of the pulp materials or combinations thereof. The formed top (2003) may also be used as a warming tray for added condiments to be heated. In addition, the bottom portion of the container may have a seat (2005) extended around the perimeter may be shaped to accept/seat a condiment package. The formulation will allow more control of the product heating without introducing any additional components to the finished package.

Embodiments of the present invention will also work with confectionaries, candies, cookies, and other food products that people desire to consume at temperatures above the temperature at which they are sold or stored.

### Exemplary Embodiment Heat-Able Container with Condiment Package (3000-4000)

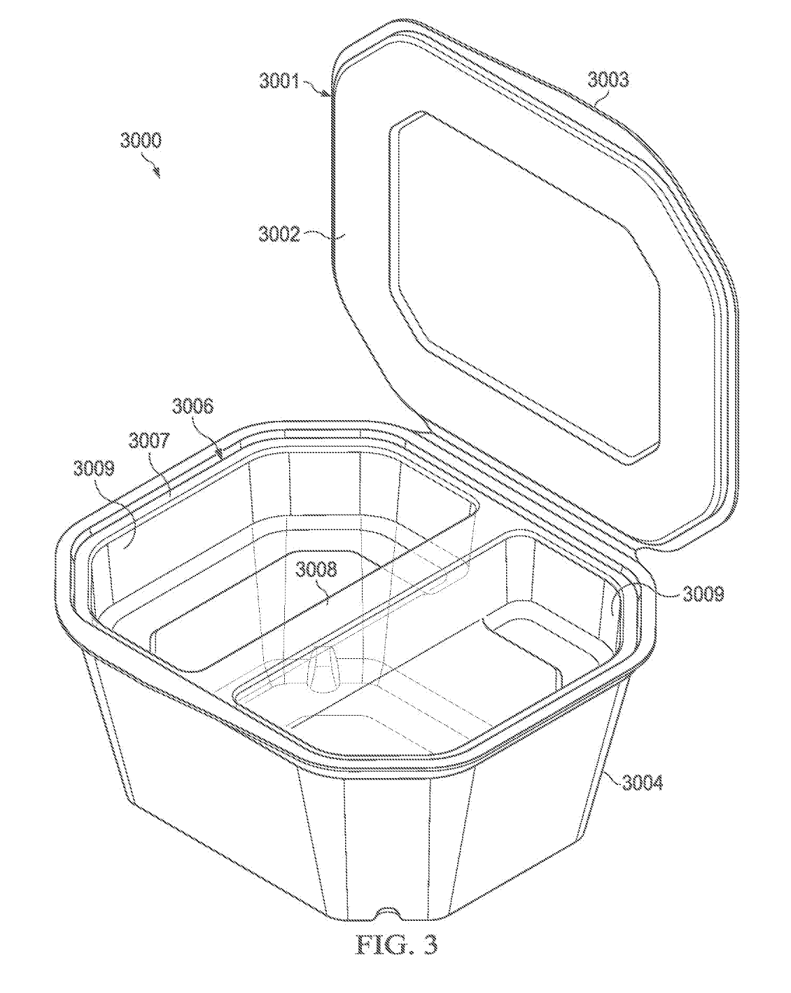

As generally illustrated in FIG. 3 (3000) a condiment package (3006) may be positioned/seated on a seat (3007) inside a heat-able container package (3001). The heat-able container (3001) comprises a closed formed top (3003) attached to a bottom portion (3004). The condiment package is shaped to mate with the heat-able container package (3001). According to an exemplary embodiment, the condiment package (3006) may be made of paper pulp and may be heated together with the container (3001) in a microwave or a hot air oven. A divider (3008) may divide the condiment package into partitions (3009) to provide space for individual condiments. For example, the container may contain tortilla chips and the condiment package may be filled with cheese and jalapenos' in individual compartments/partitions. In another example, the container may contain oatmeal and the condiment package may be filled with nuts and fruits in individual compartments/partitions. It should be noted that the two partitions (3009) in the condiment package (3006) shown in FIG. 3 (3000) are for illustration purposes only and may not be construed as a limitation. The condiment package may be partitioned into more than one partition. Similar to the aforementioned package (2000), the inside surface (3002) of the container package (3001) is coated with a barrier layer and a sealant layer that is exposed to the food side.

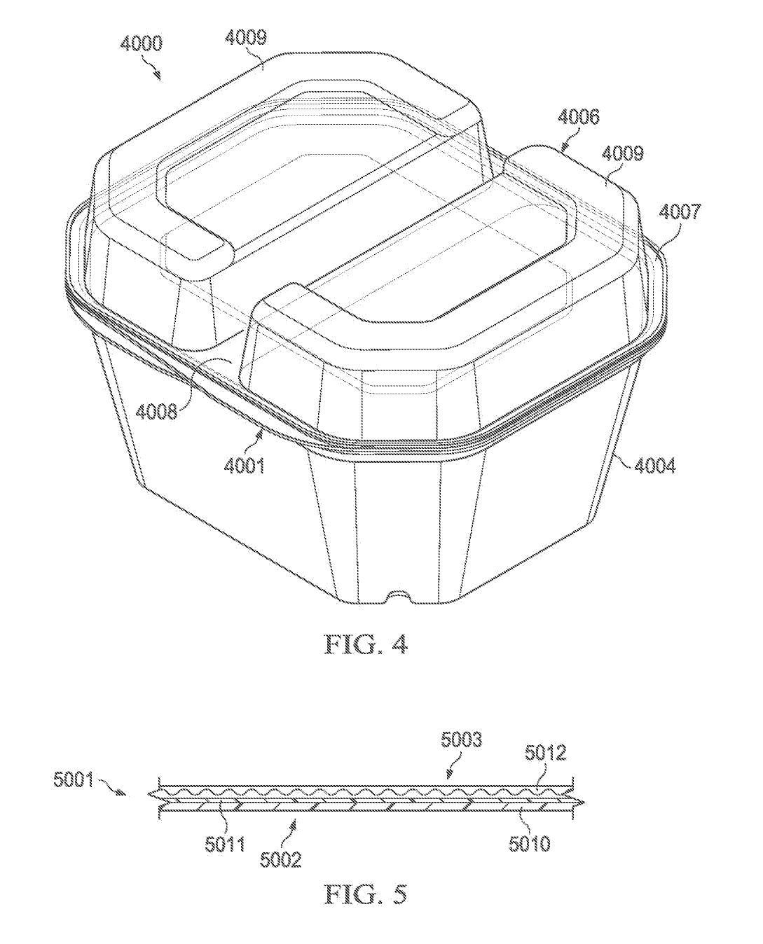

Similar to the condiment package in FIG. 3 (3000), a condiment package may be positioned on top of the formed top of a heat-able container package (4001) as illustrated in FIG. 4 (4000). The heat-able container (4001) comprises a formed top attached to a bottom portion (4004). According to an exemplary embodiment, the condiment package (4006) may be made of paper pulp and may be heated together with the container (4001). The condiment package (4006) may also be made from plastic that is transparent and enables a consumer to see the condiments through the package (4006). A divider (4008) may divide the condiment package into partitions (4009) so that space is provided for individual condiments. For example, the container may contain tortilla chips and the condiment package may be filled with cheese and jalapenos in individual compartments/partitions. In another example, the container may contain oatmeal and the condiment package may be filled with nuts and fruits in individual compartments/partitions. It should be noted that the two partitions (4009) in the condiment package (4006) shown in FIG. 4 (4000) are for illustration purposes only and may not be construed as a limitation. The condiment package (4006) may be partitioned into more than one partition. A packaging label may be affixed and wrapped around the condiment package (4006) and the container (4001). Similar to the aforementioned package (2000), the inside surface of the container (4001) may be coated with a barrier layer and a sealant layer that is exposed to the food side.

### Exemplary Embodiment Barrier Layer and Sealant Layer Cross Section (5000)

As illustrated in FIG. 5 (5001), a cross section of a side of an on-the-go food package/container is shown. The pulp material layer (5012) has a smooth outside surface (5003) and a corrugated fibrous inside surface. A barrier layer (5011) that adheres to the fibrous surface may be spray coated with a spray head. Spray coating has the advantage of getting more coverage compared to a laminate coating. The spray coated barrier layer also delaminates from the fibrous pulp layer in a conventional recycling process when the package is disposed. A sealant layer (5010) is directly applied on top of the barrier layer. The sealant layer (5010) is food safe, and therefore is exposed to the food side (5002) of the package. The sealant layer (5010) may have a material composition comprising ammonium hydroxide that is considered food safe. It should be noted that a single barrier layer (5011) and a single sealant layer (5010) as shown in FIG. 5 (5001) are for illustration purposes only and may not be construed as a limitation. Multiple barrier layers and sealant layers may be alternatively applied to the inside surface of the pulp container. After a first barrier layer and a first sealant layer is applied and cured, the layers may be combined and compressed into one layer for subsequent applications. The second and subsequent barrier and sealant layers are applied directly on top of the compressed layer. According to an exemplary embodiment, the sealant layer and the barrier layer may one layer that provides both barrier and sealing properties. According to an exemplary embodiment, applicants herein disclose an on-the-go food product/package that has direct food contact, shelf stable with moisture/oxygen barrier, and that is hermetically heat sealed with the sealant layer. In a preferred exemplary embodiment, the barrier layer provides less than 0.5 gm/pkg/day moisture vapor transmission rate (MVTR) and less than 2.0 cc/pkg/day oxygen transmission rate (OTR). In another exemplary embodiment, the weight of the pulp container only is less than 30 grams and the combined weight of the container and one layer of sealant one layer of barrier is less than 40 grams. In yet another exemplary embodiment, the weight of the pulp container is less than 60 grams. In yet another preferred exemplary embodiment, the weight of the pulp container, sealant layer, and barrier layer is less than 80 grams. In a preferred exemplary embodiment, the thickness of the container pulp wall is in between 25 mils and 50 mils. In a more preferred exemplary embodiment, the thickness of the container pulp wall is in between 15 mils and 75 mils. In the most exemplary embodiment, the thickness of the container pulp wall is less than 35 mils and the combined thickness of the barrier layer and sealant layer is less than 6 mils. In another preferred exemplary embodiment, the combined thickness of the barrier layer and sealant layer is less than 4 mils.

According to a preferred exemplary embodiment, the sealant layer and the barrier layers are food safe up to 500° C.

### On-the-go Heat-Able Package Manufacturing Method Exemplary Embodiment (7000)

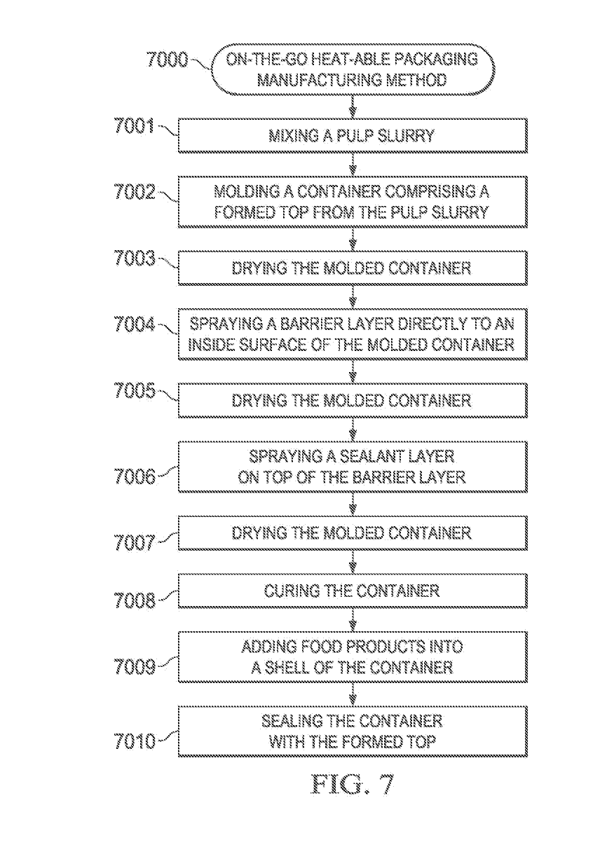

A method of making a heat-able container for storing and heating food is illustrated in FIG. 7 (7000). The method may be generally described in terms of the following steps:
(1) Mixing a pulp slurry (7001);
   Raw materials comprising natural emulsified wax and recycled corrugate material such as paper pulp or cardboard may be loaded into a pulper that mixes the materials with water to produce pulp slurry. For example, the composition of the slurry may be 5% natural emulsified wax, 10% water, and 80% recycled corrugate material. The pulp slurry may be pumped to a storage tank. A refiner and a 3 function cyclone cleaner in combination with a vibrating screen may be utilized to refine the pulp slurry to remove undesired components. The refined pulp slurry may be further pumped to a storage tank and then loaded into a mixer for consistency control. Additives such a salt and brine solution are added to the slurry, in one preferred exemplary embodiment. The percentage salt may range from 1-25% by weight. The refined and consistent pulp slurry may then be pumped to a molding station. The excess water may be recycled and pumped to the pulper or mixer so as to not generate waste water. Excess pulp may be pumped back to the pulper so that insignificant manufacturing waste is generated.
(2) Molding a container comprising a shell and a formed top from the pulp slurry (7002);
   The consistent pulp slurry may be pulled through a mold that screens on the inside of the mold. The mold may be shaped consistent with the desired container shape. For example the mold may be shaped as a rectangular bowl as shown in FIG. 1 (1000) or a rounded bowl as shown in FIG. 6 (6000). The thickness of the pulp layer in the container may be in some instances range from 15-75 mils.
(3) Drying the molded container (7003);
   The molded container from the step (7002) may be dried to drive out excess moisture.
(4) Spraying a barrier layer directly to an inside surface of the molded container (7004);
   A barrier layer may be sprayed directly on the inside surface of the molded container with a spray head. The thickness of the barrier layer may be determined by factors such as desired shelf life, type of food contents, and combinations thereof. The thickness of the barrier layer may be in some instances range from 1-10 mils. The barrier layer may be made from a material such as Michem® Coat 95 manufactured by Michelman, Inc.
(5) Drying the molded container (7005);
   The molded container from the step (7004) may be dried to drive out excess moisture.
(6) Spraying a sealant layer directly on top of the barrier layer (7006);
   A sealant layer may be sprayed directly on the inside surface of the molded container with a spray head. Spray application requires less material than a laminate application. In addition, spray applied material easily peels off during the recycling process. The thickness of the sealant layer may be determined by factors such as desired shelf life, type of food contents and combinations thereof. The thickness of the sealant layer may be in some instances range from 1-10 mils. The sealant layer may have composition that includes ammonium hydroxide.
(7) Drying the container (7007);
(8) Curing the container (7008);
   The dried container from the step (7007) may be cured in a heated mold to provide strength to the container.
(9) Adding food products into the shell (7009); and
(10) Sealing the container with the formed top (7010).

This general method summary may be augmented by the various elements described herein to produce a wide variety of invention embodiments consistent with this overall design description.

### System Summary

The present invention system anticipates a wide variety of variations in the basic theme of a heat-able container for storing and heating food therein, the container comprising a paper pulp material shaped to hold the food, a barrier layer and a sealant layer applied to an inside surface of the container; the barrier layer sandwiched between the sealant layer and the inside surface of the container.

This general system summary may be augmented by the various elements described herein to produce a wide variety of invention embodiments consistent with this overall design description.

### Method Summary

The present invention method anticipates a wide variety of variations in the basic theme of implementation, but can be generalized as a method of making a heat-able container for storing and heating food, the method comprises the steps of:

(1) Mixing a pulp slurry;

(2) Molding a container comprising a formed top from the pulp slurry;

(3) Drying the molded container;

(4) Spraying a barrier layer directly to an inside surface of the molded container;

(5) Drying the molded container;

(6) Spraying a sealant layer directly on top of the barrier layer;

(7) Drying the container;

(8) Curing the container;

(9) Adding food products into the container; and

(10) Sealing the container with the formed top.

This general method summary may be augmented by the various elements described herein to produce a wide variety of invention embodiments consistent with this overall design description.

### System/Method Variations

The present invention anticipates a wide variety of variations in the basic theme of on-the-go heat-able packages. The examples presented previously do not represent the entire scope of possible usages. They are meant to cite a few of the almost limitless possibilities.

This basic system and method may be augmented with a variety of ancillary embodiments, including but not limited to:
An embodiment wherein addition of brine solution changes thermal characteristics of said paper pulp material to facilitate selective said food heating.
An embodiment wherein addition of salt changes thermal characteristics of said paper pulp material to facilitate selective food heating.
An embodiment wherein said barrier layer moisture vapor transmission rate (MVTR) is less than 0.5 gm/package/day.
An embodiment wherein said barrier layer oxygen transmission rate (OTR) is less than 2 cc/package/day.
An embodiment wherein said sealant layer hermetically seals said container.
An embodiment wherein said barrier layer is food safe.
An embodiment wherein said sealant layer is food safe.
An embodiment wherein said barrier layer is configured to extend said package shelf life by at least 6 months.
An embodiment wherein the heat-able container further comprises a condiment package that is shaped to fit outside a formed top of said container.
An embodiment wherein the heat-able container further comprises a condiment package that is shaped to fit inside a formed top of said container.
An embodiment wherein said condiment package is made from plastic.
An embodiment wherein said condiment package is made from thermal formed pulp.
An embodiment wherein said container and said condiment package are heated together.
An embodiment wherein said formed top is configured to warm said condiment package contents.
An embodiment wherein said condiment package comprises at least one partition.
An embodiment wherein the heat-able container further comprises plural sealant layers and plural barrier layers.
An embodiment wherein said container is heated in a microwave.
An embodiment wherein said container is heated in a hot air microwave oven.
An embodiment wherein said container weight is less than 30 grams.
An embodiment wherein the combined weight of said container, said sealant layer, and said barrier layer is less than 40 grams.
An embodiment wherein said container wall thickness is less than 35 mils.
An embodiment wherein the combined thickness of one layer of said sealant layer and said barrier layer is less than 6 mils.

One skilled in the art will recognize that other embodiments are possible based on combinations of elements taught within the above invention description.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A method of making a heat-able container for storing and heating food, said method comprises the steps of:
(1) mixing a pulp slurry;
(2) molding a container comprising a formed top from said pulp slurry;
(3) drying said molded container;
(4) spraying a barrier layer directly to an inside surface of said container;
(5) drying said container;
(6) spraying a sealant layer directly on top of said barrier layer;
(7) drying said container;
(8) curing said container;
(9) adding food products into said container; and
(10) sealing said container with said formed top.

2. The method of claim 1 wherein said process steps 4-6 are at least repeated twice to apply plural barrier and sealant layers.

3. The method of claim 1 further comprises the steps of:
(11) positioning a condiment package on an outside surface of said formed top; and
(12) affixing a packaging label around said container and said condiment package.

4. The method of claim 1 further comprises the steps of:
(11) positioning a condiment package inside of said container; and
(12) affixing a packaging label around said container and said formed top.

5. The method of claim 1 wherein said process steps generate no waste water.
